(19) United States
(12) Patent Application Publication
(10) Pub. No.: US 2012/0060149 A1
(43) Pub. Date: Mar. 8, 2012

(54) INTEGRATED MULTIMEDIA APPLICATION FOR MOBILE DEVICES

(76) Inventor: Brad Kimura, (US)

(21) Appl. No.: 13/226,464

(22) Filed: Sep. 6, 2011

Related U.S. Application Data
(60) Provisional application No. 61/380,031, filed on Sep. 3, 2010.

(51) Int. Cl. G06F 9/445

(52) U.S. Cl. 717/120; 717/178

(57) ABSTRACT

A method and a device are disclosed for downloading an integrated multimedia mobile application including a description of a multimedia content accessible from within the mobile downloadable application, a player to play the multimedia content, and the multimedia content. In an example typical operation, a user views a list of downloadable mobile applications, such as Apple Corporation's iPhone apps, listed as icons, selects an integrated multimedia application, reads a description of the content within the selected mobile application, and launches a player from within the application to play the content. Such functionality may be provided by a provider such as a mobile communication service provider, a content provider, an application provider, or a combination thereof.

### TECHNICAL FIELD

This application claims priority back to U.S. Provisional application 61/380,031. This application relates generally to mobile devices. More specifically, this application relates to downloadable and/or streaming multimedia applications including integrated content, description of content, and media player.

### SUMMARY

In aspects of the present disclosures, a downloadable integrated application for mobile computing devices is disclosed. The downloadable integrated application includes contents, a description of the contents, and an executable programs configured to process the contents.

In further aspects of the present disclosures, a method of building an integrated application is disclosed, including determining contents, determining a description of the contents, determining an executable program to process the contents, and including and packaging the contents, the description, and the executable program into a single integrated application.

In still further aspects of the disclosure, a method of downloading content onto a mobile computing device is disclosed. The method includes enabling a user to select an integrated application for download to the mobile computing device. The method further includes enabling the user to read a description of contents of the integrated application and enabling the user to launch an executable program to process the contents. The method further includes enabling the user to process the contents of the integrated application using the executable program.

### BRIEF DESCRIPTION OF THE DRAWINGS

The drawings, when considered in connection with the following description, are presented for the purpose of facilitating an understanding of the subject matter sought to be protected.

FIG. 1 shows an embodiment of a network computing environment wherein the disclosure may be practiced;

FIG. 2 shows an embodiment of a computing device that may be used in the network computing environment of FIG. 1;

FIG. 3 shows a mobile communication device configured to allow the downloading and use of an integrated app; and

FIG. 4 shows an illustrative process of downloading and playing an integrated app.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while following description references mobile phones and smartphones, it will be appreciated that the disclosure may be used with other types of mobile computing and communication devices, such as Personal Digital Assistants (PDA), netbook computers, tablet computers, and the like.

Briefly described, a device and a method are disclosed including a mobile computing device configured to download and/or stream an integrated multimedia mobile application including a description of a multimedia content accessible from within the mobile application, a player to play the multimedia content, and the multimedia content. In a example typical operation, a user views a list of downloadable mobile applications, such as Apple Corporation's iPhone apps, listed as icons, selects an integrated multimedia application, reads a description of the content within the selected mobile application, and launches a player from within the application to play the content. Such functionality may be provided by a provider such as a mobile communication service provider, a content provider, an application provider, or a combination thereof.

Mobile computing devices, such as smartphones, netbook computers, tablet computers, PDAs, and the like have become ubiquitous in recent years, both in business and as personal electronic devices. A smartphone is generally regarded as a mobile phone, such as a cell phone, that provides more advanced computing capabilities, connectivity, and functionalities than the more common cell phones, which only offer basic phone service and a few additional functions such as calendar or simple games. Smarphones and other similar mobile computing devices may be regarded as handheld computers having telephonic communication capabilities as a primary feature. Mobile communication and computing devices, such as smartphones, are generally capable of running applications based on platforms such as Java ME or BREW, and allowing a user to install and run more advanced applications based on a specific computing platform. Such devices generally have complete operating system software providing a platform for application developers. Growth in demand for advanced mobile devices having powerful processors, large memories, high resolution and/or touch-sensitive screens, and open operating systems has been very significant in the mobile phone market for several years. According to various studies in the industry, in 2010 over 45 million people in the United States owned smartphones and it is the fastest growing segment of the mobile phone market, which comprised 235 million subscribers in the United States alone. Smartphones and other similar devices command similar customer bases in Europe and far east, as well as in other regions of the world.

Software applications, sometimes referred to as “Apps” in the market, constitute an important driver for the sale and popularity of smartphones. The computing power and functionality of smartphones are often used to download and use the apps available for download from various websites. Apps are generally executable programs that are downloaded and executed on the mobile computing device to perform various functions, such as provide sports news, access to electronic mail (email), access to the Global Positioning System (GPS), playing video games, playing music and video, and the like. Apps that play multimedia content, such as various media players, are generally downloaded separately from the multimedia content. Multimedia content, such as music and video are available in many formats, which are often incompatible with each other. For example, Windows Media Player (WMP) files usually have a file extension of “.wma”, while Real Player plays files with “.rm” extensions. These files do not have compatible formats and each one needs its own player to play it.

User who often download apps for entertainment, business, or other audio-visual purposes may benefit from an integrated app that includes the multimedia content, description of the content, and a player that plays the content, packaged in the form of a single downloadable app. Such apps may include music, video, movies, TV shows, concert recordings, training material, and the like. Multimedia content providers and/or app providers can use such integrated apps to provide enhanced information and control over the multimedia content in the form of advertising, special playback features for the content, and the like.

### Illustrative Operating Environment

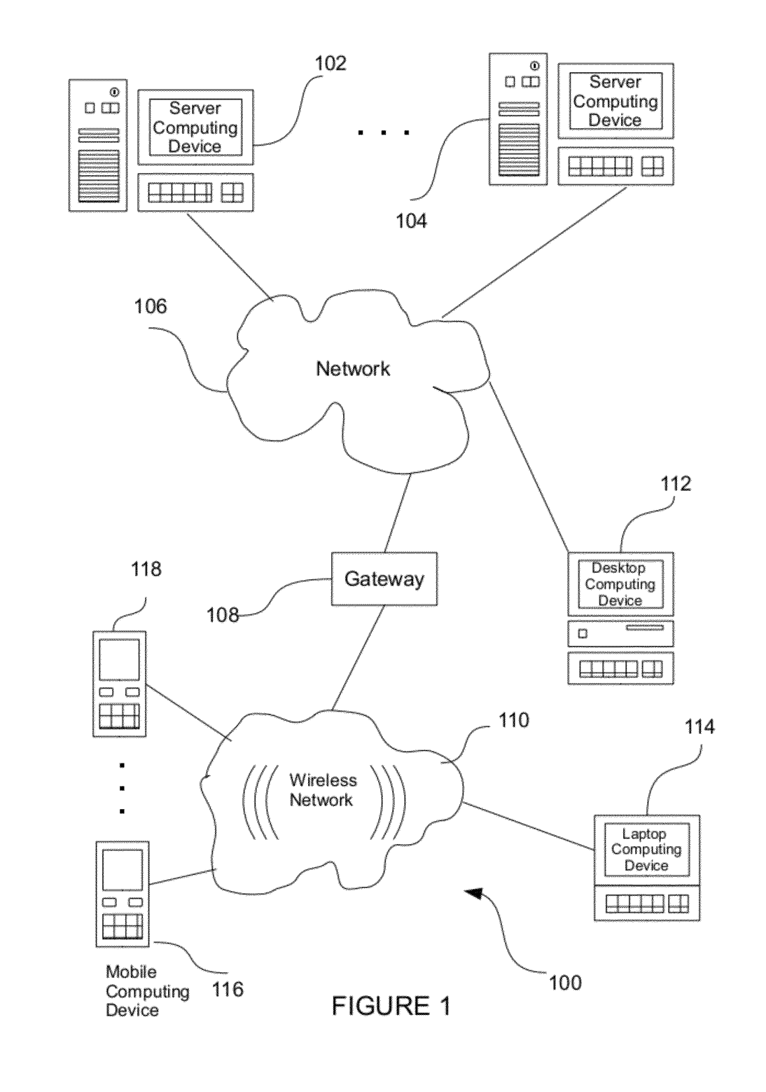

FIG. 1 shows components of an illustrative environment in which the disclosure may be practiced. Not all the shown components may be required to practice the disclosure, and variations in the arrangement and type of the components may be made without departing from the spirit or scope of the disclosure. System 100 may include Local Area Networks (LAN) and Wide Area Networks (WAN) shown collectively as Network 106, wireless network 110, gateway 108 configured to connect remote and/or different types of networks together, client computing devices 112-118, and server computing devices 102-104.

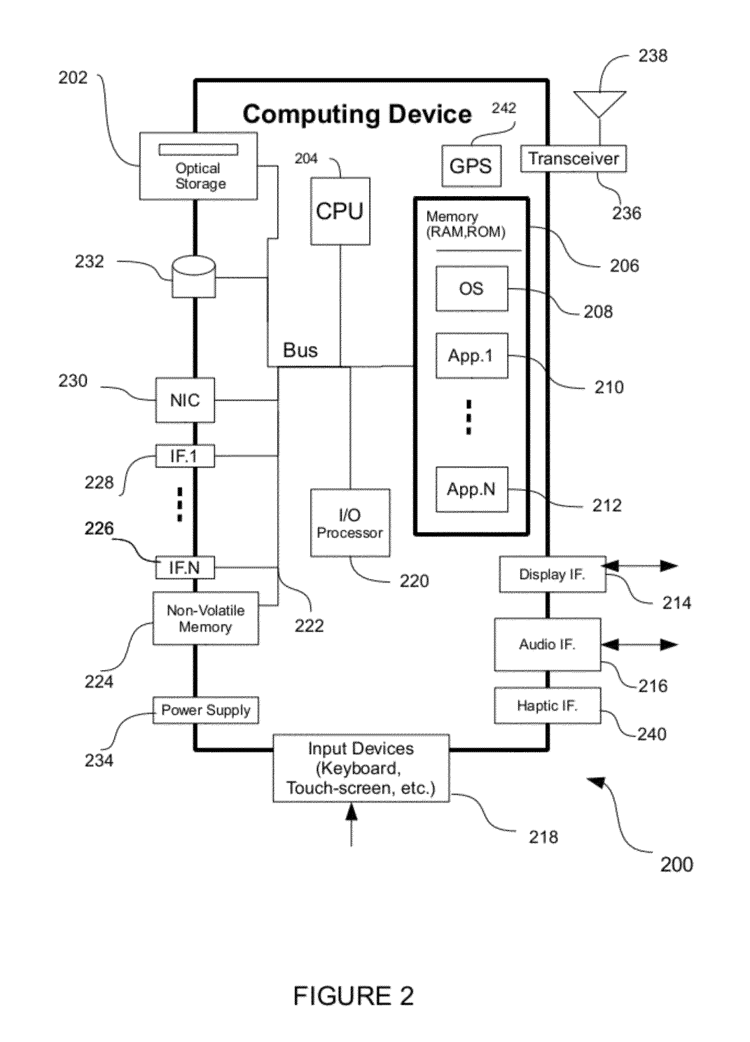

One embodiment of a computing device usable as one of client computing devices 112-118 is described in more detail below with respect to FIG. 2. Briefly, however, client computing devices 112-118 may include virtually any device capable of receiving and sending a message over a network, such as wireless network 110, or the like. Such devices include portable devices such as, cellular telephones, smart phones, display pagers, radio frequency (RF) devices, music players, digital cameras, infrared (IR) devices, Personal Digital Assistants (PDAs), handheld computers, laptop computers, wearable computers, tablet computers, integrated devices combining one or more of the preceding devices, or the like. Client device 112 may include virtually any computing device that typically connects using a wired communications medium such as personal computers, multiprocessor systems, microprocessor-based or programmable consumer electronics, network PCs, or the like. In one embodiment, one or more of client devices 112-118 may also be configured to operate over a wired and/or a wireless network.

Client devices 112-118 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphic may be displayed.

A web-enabled client device may include a browser application that is configured to receive and to send web pages, web-based messages, or the like. The browser application may be configured to receive and display graphic, text, multimedia, or the like, employing virtually any web based language, including a wireless application protocol messages (WAP), or the like. In one embodiment, the browser application may be enabled to employ one or more of Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information.

Client computing devices 12-118 also may include at least one other client application that is configured to receive content from another computing device, including, without limit, server computing devices 102-104. The client application may include a capability to provide and receive textual content, multimedia information, or the like. The client application may further provide information that identifies itself, including a type, capability, name, or the like. In one embodiment, client devices 112-118 may uniquely identify themselves through any of a variety of mechanisms, including a phone number, Mobile Identification Number (MIN), an electronic serial number (ESN), mobile device identifier, network address, such as IP (Internet Protocol) address, Media Access Control (MAC) layer identifier, or other identifier. The identifier may be provided in a message, or the like, sent to another computing device.

Client computing devices 112-118 may also be configured to communicate a message, such as through email, Short Message Service (SMS), Multimedia Message Service (MMS), instant messaging (IM), internet relay chat (IRC), Mardam-Bey's IRC (mIRC), Jabber, or the like, to another computing device. However, the present disclosure is not limited to these message protocols, and virtually any other message protocol may be employed.

Client devices 112-118 may further be configured to include a client application that enables the user to log into a user account that may be managed by another computing device. Such user account, for example, may be configured to enable the user to receive emails, send/receive IM messages, SMS messages, access selected web pages, download scripts, applications, or a variety of other content, or perform a variety of other actions over a network. However, managing of messages or otherwise accessing and/or downloading content, may also be performed without logging into the user account. Thus, a user of client devices 112-118 may employ any of a variety of client applications to access content, read web pages, receive/send messages, or the like. In one embodiment, for example, the user may employ a browser or other client application to access a web page hosted by a Web server implemented as server computing device 102. In one embodiment, messages received by client computing devices 112-118 may be saved in non-volatile memory, such as flash and/or PCM, across communication sessions and/or between power cycles of client computing devices 112-118.

Wireless network 110 may be configured to couple client devices 114-118 to network 106. Wireless network 110 may include any of a variety of wireless sub-networks that may further overlay stand-alone ad-hoc networks, and the like, to provide an infrastructure-oriented connection for client devices 114-118. Such sub-networks may include mesh networks, Wireless LAN (WLAN) networks, cellular networks, and the like. Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as client devices 114-118 with various degrees of mobility. For example, wireless network 110 may enable a radio connection through a radio network access such as Global System for Mobil communication (GSM), General Packet Radio Services (GPRS), Enhanced Data GSM Environment (EDGE), WEDGE, Bluetooth, High Speed Downlink Packet Access (HSDPA), Universal Mobile Telecommunications System (UMTS), Wi-Fi, Zigbee, Wideband Code Division Multiple Access (WCDMA), and the like. In essence, wireless network 110 may include virtually any wireless communication mechanism by which information may travel between client devices 102-104 and another computing device, network, and the like.

Network 106 is configured to couple one or more servers depicted in FIG. 1 as server computing devices 102-104 and their respective components with other computing devices, such as client device 112, and through wireless network 110 to client devices 114-118. Network 106 is enabled to employ any form of computer readable media for communicating information from one electronic device to another. Also, network 106 may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another.

Communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. Network 106 may include any communication method by which information may travel between computing devices. Additionally, communication media typically may enable transmission of computer-readable instructions, data structures, program modules, or other types of content, virtually without limit. By way of example, communication media includes wired media such as twisted pair, coaxial cable, fiber optics, wave guides, and other wired media and wireless media such as acoustic, RF, infrared, and other wireless media.

### Illustrative Computing Device Configuration

FIG. 2 shows an illustrative computing device 200 that may represent any one of the server and/or client computing devices shown in FIG. 1. A computing device represented by computing device 200 may include less or more than all the components shown in FIG. 2 depending on the functionality needed. For example, a mobile computing device may include the transceiver 236 and antenna 238, while a server computing device 102 of FIG. 1 may not include these components. Those skilled in the art will appreciate that the scope of integration of components of computing device 200 may be different from what is shown. As such, some of the components of computing device 200 shown in FIG. 2 may be integrated together as one unit. For example, NIC 230 and transceiver 236 may be implemented as an integrated unit. Additionally, different functions of a single component may be separated and implemented across several components instead. For example, different functions of I/O processor 220 may be separated into two or more processing units.

With continued reference to FIG. 2, computing device 200 includes optical storage 202, Central Processing Unit (CPU) 204, memory module 206, display interface 214, audio interface 216, input devices 218, Input/Output (I/O) processor 220, bus 222, non-volatile memory 224, various other interfaces 226-228, Network Interface Card (NIC) 320, hard disk 232, power supply 234, transceiver 236, antenna 238, haptic interface 240, and Global Positioning System (GPS) unit 242. Memory module 206 may include software such as Operating System (OS) 208, and a variety of software application programs 210-212. Computing device 200 may also include other components not shown in FIG. 2. For example, computing device 200 may further include an illuminator (for example, a light), graphic interface, and portable storage media such as USB drives. Computing device 200 may also include other processing units, such as a math co-processor, graphics processor/accelerator, and a Digital Signal Processor (DSP).

Optical storage device 202 may include optical drives for using optical media, such as CD (Compact Disc), DVD (Digital Video Disc), and the like. Optical storage devices 202 may provide inexpensive ways for storing information for archival and/or distribution purposes.

Central Processing Unit (CPU) 204 may be the main processor for software program execution in computing device 200. CPU 204 may represent one or more processing units that obtain software instructions from memory module 206 and execute such instructions to carry out computations and/or transfer data between various sources and destinations of data, such as hard disk 232, I/O processor 220, display interface 214, input devices 218, non-volatile memory 224, and the like.

Memory module 206 may include RAM (Random Access Memory), ROM (Read Only Memory), and other storage means, mapped to one addressable memory space. Memory module 206 illustrates one of many types of computer storage media for storage of information such as computer readable instructions, data structures, program modules or other data. Memory module 206 may store a basic input/output system (BIOS) for controlling low-level operation of computing device 200. Memory module 206 may also store OS 208 for controlling the general operation of computing device 200. It will be appreciated that OS 208 may include a general-purpose operating system such as a version of UNIX, or LINUX™, or a specialized client communication operating system such as Windows Mobile™, or the Symbian® operating system. OS 208 may, in turn, include or interface with a Java virtual machine (JVM) module that enables control of hardware components and/or operating system operations via Java application programs.

Memory module 206 may further include one or more distinct areas (by address space and/or other means), which can be utilized by computing device 200 to store, among other things, applications and/or other data. For example, one area of memory module 206 may be set aside and employed to store information that describes various capabilities of computing device 200, a device identifier, and the like. Such identification information may then be provided to another device based on any of a variety of events, including being sent as part of a header during a communication, sent upon request, or the like. One common software application is a browser program that is generally used to send/receive information to/from a web server. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web based languages may also be employed. In one embodiment, using the browser application, a user may view an article or other content on a web page with one or more highlighted portions as target objects.

Display interface 214 may be coupled with a display unit (not shown), such as liquid crystal display (LCD), gas plasma, light emitting diode (LED), or any other type of display unit that may be used with computing device 200. Display units coupled with display interface 214 may also include a touch sensitive screen arranged to receive input from an object such as a stylus or a digit from a human hand. Display interface 214 may further include interface for other visual status indicators, such Light Emitting Diodes (LED), light arrays, and the like. Display interface 214 may include both hardware and software components. For example, display interface 214 may include a graphic accelerator for rendering graphic-intensive outputs on the display unit. In one embodiment, display interface 214 may include software and/or firmware components that work in conjunction with CPU 204 to render graphic output on the display unit.

Audio interface 216 is arranged to produce and receive audio signals such as the sound of a human voice. For example, audio interface 216 may be coupled to a speaker and microphone (not shown) to enable communication with a human operator, such as spoken commands, and/or generate an audio acknowledgement for some action.

Input devices 218 may include a variety of device types arranged to receive input from a user, such as a keyboard, a keypad, a mouse, a touchpad, a touch-screen (described with respect to display interface 214), a multi-touch screen, a microphone for spoken command input (describe with respect to audio interface 216), and the like.

I/O processor 220 is generally employed to handle transactions and communications with peripheral devices such as mass storage, network, input devices, display, and the like, which couple computing device 200 with the external world. In small, low power computing devices, such as some mobile devices, functions of the I/O processor 220 may be integrated with CPU 204 to reduce hardware cost and complexity. In one embodiment, I/O processor 220 may the primary software interface with all other device and/or hardware interfaces, such as optical storage 202, hard disk 232, interfaces 226-228, display interface 214, audio interface 216, and input devices 218.

An electrical bus 222 internal to computing device 200 may be used to couple various other hardware components, such as CPU 204, memory module 206, I/O processor 220, and the like, to each other for transferring data, instructions, status, and other similar information.

Non-volatile memory 224 may include memory built into computing device 200, or portable storage medium, such as USB drives that may include PCM arrays, flash memory including NOR and NAND flash, pluggable hard drive, and the like. In one embodiment, portable storage medium may behave similarly to a disk drive. In another embodiment, portable storage medium may present an interface different than a disk drive, for example, a read-only interface used for loading/supplying data and/or software.

Various other interfaces 226-228 may include other electrical and/or optical interfaces for connecting to various hardware peripheral devices and networks, such as IEEE 1394 also known as FireWire, Universal Serial Bus (USB), Small Computer Serial Interface (SCSI), parallel printer interface, Universal Synchronous Asynchronous Receiver Transmitter (USART), Video Graphics Array (VGA), Super VGA (SVGA), and the like.

Network Interface Card (NIC) 230 may include circuitry for coupling computing device 200 to one or more networks, and is generally constructed for use with one or more communication protocols and technologies including, but not limited to, Global System for Mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth, Wi-Fi, Zigbee, UMTS, HSDPA, WCDMA, WEDGE, or any of a variety of other wired and/or wireless communication protocols.

Hard disk 232 is generally used as a mass storage device for computing device 200. In one embodiment, hard disk 232 may be a Ferro-magnetic stack of one or more disks forming a disk drive embedded in or coupled to computing device 200. In another embodiment, hard drive 232 may be implemented as a solid-state device configured to behave as a disk drive, such as a flash-based hard drive. In yet another embodiment, hard drive 232 may be a remote storage accessible over network interface 230 or another interface 226, but acting as a local hard drive. Those skilled in the art will appreciate that other technologies and configurations may be used to present a hard drive interface and functionality to computing device 200 without departing from the spirit of the present disclosure.

Power supply 234 provides power to computing device 200. A rechargeable or non-rechargeable battery may be used to provide power. The power may also be provided by an external power source, such as an AC adapter or a powered docking cradle that supplements and/or recharges a battery.

Transceiver 236 generally represents transmitter/receiver circuits for wired and/or wireless transmission and receipt of electronic data. Transceiver 236 may be a stand-alone module or be integrated with other modules, such as NIC 230. Transceiver 236 may be coupled with one or more antennas for wireless transmission of information.

Antenna 238 is generally used for wireless transmission of information, for example, in conjunction with transceiver 236, NIC 230, and/or GPS 242. Antenna 238 may represent one or more different antennas that may be coupled with different devices and tuned to different carrier frequencies configured to communicate using corresponding protocols and/or networks. Antenna 238 may be of various types, such as omni-directional, dipole, slot, helical, and the like.

Haptic interface 240 is configured to provide tactile feedback to a user of computing device 200. For example, the haptic interface may be employed to vibrate computing device 200, or an input device coupled to computing device 200, such as a game controller, in a particular way when an event occurs, such as hitting an object with a car in a video game.

Global Positioning System (GPS) unit 242 can determine the physical coordinates of computing device 200 on the surface of the Earth, which typically outputs a location as latitude and longitude values. GPS unit 242 can also employ other geo-positioning mechanisms, including, but not limited to, triangulation, assisted GPS (AGPS), E-OTD, CI, SAI, ETA, BSS or the like, to further determine the physical location of computing device 200 on the surface of the Earth. It is understood that under different conditions, GPS unit 242 can determine a physical location within millimeters for computing device 200. In other cases, the determined physical location may be less precise, such as within a meter or significantly greater distances. In one embodiment, however, a mobile device represented by computing device 200 may, through other components, provide other information that may be employed to determine a physical location of the device, including for example, a MAC address.

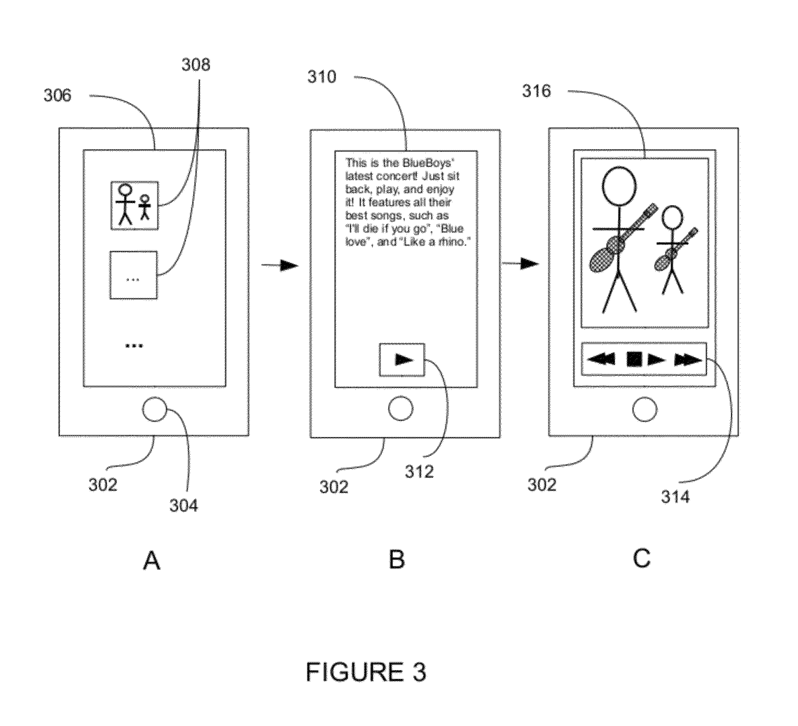

FIG. 3 shows a mobile communication device configured to allow the downloading and use of an integrated app. An example mobile computing device 302 includes a hardware button 304, a screen 306 for showing software objects 308. In various embodiments, one or more hardware buttons 304 may function as a power button, a navigation button, a menu button, a selection button, a programmable function button, and the like. In various embodiments, screen 306 may be color or black and white. In some embodiments, screen 306 is touch screen while in other embodiments, screen 306 is a multi-touch screen that responds to multiple touches simultaneously to perform various functions such as to enlarge or reduce the size of a picture or document displayed on screen 306.

In operation, in various embodiments, a user goes through three phases A, B, and C for downloading and playing a multimedia app. Those skilled in the art will appreciate that in other embodiments, these phases may be split into more phases or be combined into fewer phases. In phase A, the user may download a service provider's web page to see a selection or list of apps that may be selected and downloaded to the mobile computing device. The apps may appear as links, icons (active software objects appearing as small images), soft buttons, or other software objects that upon selection, for example, by being clicked on, cause a software application, such as a media player or a browser window, to be executed on mobile computing device 302. The apps may include both customary non-integrated apps and integrated multimedia apps 308.

In phase B, in various embodiments, upon the user's selection of an integrated multimedia app 308, description 310 of the app appears on screen 306 for the user to review. If the user wants to proceed, the user selects a play button 312 to launch an executable application, such as a player, to play content included in integrated multimedia app 308. Description 310 may include a simple text message, images, links to other information, icons, advertisements relate to or unrelated to the content of integrated multimedia app 308, and the like. As noted above, description 310 is included within integrated multimedia app 308 as a component and is accessed after the icon for integrated multimedia 308 is selected in phase A. This is in contrast to descriptions about content that may be available from sources external to the content, such as reviews by others, description on a webpage distinct from the app, and the like.

In phase C, in various embodiments, a media player 314, which is an integral part of the integrated multimedia app 308, is launched to play content 316, which is also an integral part of the integrated multimedia app 308. Media player 314 generally includes various playback controls, such as play, stop, pause, fast forward, rewind, and the like. Those skilled in the art will appreciate that the contents may be different types of data than multimedia data and the player may be other types of executable programs that act upon such different types of data. For example, the different types of data may include financial numbers, text, drawings, and the like, and the other types of executable programs may include spreadsheet programs, word processing programs, and drawing programs, respectively.

In the mobile device business and usage environment, an integrated multimedia app, which includes the description, the player, and the content integrated and available for download as a single app, may be highly useful and convenient for the users, the content providers, and the service providers making the content available to the users. This is in contrast to a player available as a separate app, loading different contents from various and different sources than the player, and the descriptions of the contents from still other sources different than the sources of the player and/or the contents.

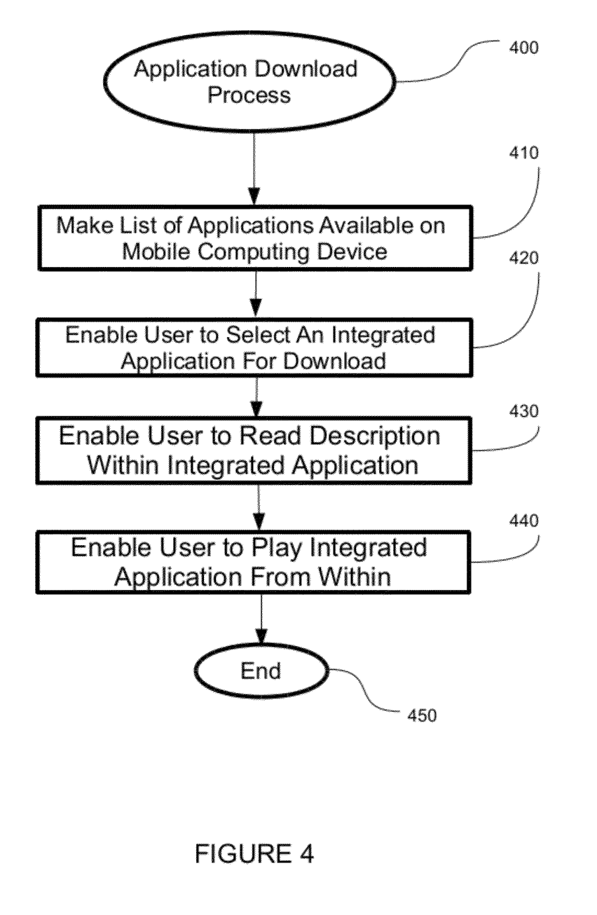

FIG. 4 shows an illustrative process of downloading and playing an integrated app. Integrated multimedia apps may include music, video, movies, TV shows, concert recordings, event recordings, sporting events, and the like. Process 400 proceeds to block 410 where a list of integrated multimedia apps are made available to users by a provider such as the communication service provider, the content provider, and/or the app provider. The process proceeds to block 420.

At block 420, the provider enables the user to select an integrated multimedia app by clicking an icon, a link, or other software objects, for download. The process proceeds to block 430.

At block 430, the user is enabled to read a description of the contents included with the integrated multimedia app. Next, the process proceeds to block 440.

At block 440, the user is enabled to launch a player integrated with and included in the downloaded integrated multimedia application. The player may be used conventionally to play the contents also downloaded with the integrated multimedia application.

Next, the process proceeds to block 450 and terminates.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

The above specification, examples, and data provide a complete description of the manufacture and use of the composition of the invention. Since many embodiments of the invention can be made without departing from the spirit and scope of the invention, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

What is claimed is:

1. A downloadable integrated application for mobile computing devices, the downloadable integrated application comprising:
contents;
a description of the contents; and
an executable programs configured to process the contents.

2. The downloadable integrated application of claim 1, wherein the contents are multimedia data.

3. The downloadable integrated application of claim 1, wherein the description of the contents is text.

4. The downloadable integrated application of claim 3, wherein the description of the contents includes an application launch button configured to launch the executable program.

5. The downloadable integrated application of claim 3, wherein the description comprises advertising.

6. The downloadable integrated application of claim 1, wherein the executable program is a media player configured to play the contents.

7. The downloadable integrated application of claim 1, wherein the mobile computing device is a smartphone.

8. The downloadable integrated application of claim 1, wherein the mobile computing device is a tablet computer.

9. A method of building an integrated application, the method comprising:
determining contents;
determining a description of the contents;
determining an executable program to process the contents; and
including and packaging the contents, the description, and the executable program into a single integrated application.

10. The method of claim 9, further comprising configuring the single integrated application as a downloadable app for mobile computing devices.

11. The method of claim 10, wherein the mobile computing device comprises a smartphone.

12. The method of claim 10, wherein the mobile computing device comprises a tablet computer.

13. The method of claim 9, wherein the content comprises multimedia data.

14. The method of claim 9, wherein the description comprises text and images.

15. The method of claim 14, wherein the description comprises an advertisement.

16. The method of claim 9, wherein the executable program comprises a media player.

17. A method of downloading content onto a mobile computing device, the method comprising:
enabling a user to select an integrated application for download to the mobile computing device;
enabling the user to read a description of contents of the integrated application;
enabling the user to launch an executable program to process the contents of the integrated application; and
enabling the user to process the contents of the integrated application using the executable program.

18. The method of claim 17, wherein the contents comprise multimedia data.

19. The method of claim 18, wherein the executable program comprises a media player configured to play the multimedia data.

20. The method of claim 17, wherein the mobile computing device comprises a smartphone.
